(19) United States
(12) Patent Application Publication
(10) Pub. No.: US 2002/0136826 A1
(43) Pub. Date: Sep. 26, 2002

(54) NON-DRYING VISCOUS AGENT FOR TREATING SURFACES

(76) Inventors: THOMAS TYBORSKI, DUESSELDORF (DE); WERNER LUEDECKE, ERKRATH (DE)

Correspondence Address: HENKEL CORPORATION, 2500 RENAISSANCE BLVD, STE 200, GULPH MILLS, PA, 19406, US

(21) Appl. No.: 09/424,401

(22) PCT Filed: May 14, 1998
(86) PCT No.: PCT/EP98/02849

(30) Foreign Application Priority Data
May 23, 1997 (DE) 197 21 590.4

(51) Int. Cl. B05D 7/22; B05D 1/02; B05D 1/28; B05D 1/18

(52) U.S. Cl. 427/154; 427/421; 427/435; 427/428; 427/230; 427/236; 427/239

(57) ABSTRACT

A process for treating food-contact surfaces is presented in which a surface treatment composition is applied to a food-contact surface. The surface treatment composition contains 90 to 98.5% by weight of water, 1 to 4% by weight of a hygroscopic component, 0.2 to 2% by weight of a preservative, and a thickener added in such a quantity so that the viscosity of the surface treatment composition is in the range of from 2,000 to 10,000 mPas, as measured at 22° C. with a Brookfield viscometer, spindle 3, at 12 r.p.m.. Surfaces treated by this process are easily freed of adhering soils by wiping with a damp cloth or by spraying with water.

This invention relates to a non-drying, viscous surface treatment composition with which surfaces in the food industry can be protected against soiling. The surfaces to be treated are, on the one hand, containers intended for accommodating foods, for example transit containers, storage containers, tanks and the like. Such containers are normally made of stainless steel, enamelled steel, lacquered steel or plastics, for example PVC, polyethylene or polypropylene. On the other hand, the surfaces to be treated are surfaces of equipment used in the food-processing industry such as, for example, walls, ceilings, tables, trays, pipes or ventilation systems. Surfaces such as these become soiled above all by attracting dust. They consist, for example, of glass, stainless steel, aluminium, lacquered steel, zinc or galvanized steel, stone or ceramics.

If foods come into contact with, and dry on, surfaces, various problems arise, namely: difficulties in emptying of containers, losses through adhering product residues and difficulties in subsequent cleaning operations.

Accordingly, there is a need for a composition with which the surfaces mentioned above can be coated, optionally after cleaning. This composition would prevent foods from adhering to, and drying on, the surfaces mentioned. Accordingly, the foods, for example meat and sausage products, could be removed easily and completely from their containers, even after prolonged storage. At the same time, there is a need for a composition with which other surfaces in the food-processing industry could be coated to prevent soil, for example in the form of dust, from firmly adhering to them. On the contrary, treatment with the composition in question would ensure that the surfaces could be easily and completely freed from adhering soils by wiping with a damp cloth or by spraying with water.

The problem addressed by the present invention was to provide such a composition. This problem has been solved by a surface treatment composition containing

90 to 98.5% by weight of water,

1 to 4% by weight of a hygroscopic component,

0.2 to 2% by weight of preservative and thickener in such a quantity that the viscosity of the mixture (as measured at 22° C. with a Brookfield viscosimeter, spindle 3, 12 r.p.m.) is in the range from 2,000 to 10,000 mPas.

The combination according to the invention of water, a hygroscopic component, a preservative and a thickener or gelling agent gives a viscous liquid which can be applied to the surfaces mentioned at the beginning. The composition prevents foods from coming into direct contact with, and drying on, the surface. The addition of preservatives, which can also act as antioxidants, prevents or retards contamination or ageing of the surface treatment composition.

The hygroscopic ingredients present prevent complete drying out on the surfaces. Accordingly, foods are unable to dry on the treated surfaces. Soil, for example dust, settling on correspondingly treated surfaces can readily be removed by wiping with a damp cloth or by spraying with water. Overall, synergistic effects are obtained and lead to the following properties:

firmly adhering, non-running film on all the usual surfaces, such as plastics, metals, ceramics, stone, etc.

the film does not dry out completely

contact with foods is possible

complete emptying of food equipment, for example transit containers, storage containers etc., because product residues do not dry out on the surfaces

clearly reduced production residues on the surfaces

easier cleaning procedures because soils settle on the film and can be easily removed with it (for example by spraying with water)

easy removability by spraying (soluble in water)

protection of surfaces against contamination with dust and soil

usable on various surfaces (plastics, glass, ceramics, metals; even on sensitive surfaces, such as galvanized metals and non-ferrous metals).

The effect of the thickeners or gelling agents is to ensure that the surface treatment composition does not run off completely after application, but instead forms an adhering film. The type of thickener used and the concentration in which it is used are preferably selected so that the viscosity of the surface treatment composition (as measured at 22° C. with a Brookfield viscosimeter, spindle No. 3, 12 r.p.m.) is preferably in the range from about 4,000 to about 6,000 mPas. To establish this viscosity, it is normally sufficient for the surface treatment composition to contain about 0.3 to about 2% by weight of thickener.

Since the surface treatment composition according to the invention can come into direct contact with foods in use, it preferably contains only those ingredients which have been locally approved for contact with foods. So far as Germany is concerned, the relevant legislation is documented in the “Verordnung über die Zulassung von Zusatzstoffen zu Lebensmitteln” (Zusatzstoffverordnung—ZZuIV; §1, §2, §3, §5 Anlagen 1,2,3,5).

Accordingly, the hygroscopic component is preferably selected from:

| Substance | EEC No. |
|---|---|
| Glycerol | (E422) |
| Aluminium oxide | — |
| Carbonate | — |
| Sodium carbonate | — |
| Potassium carbonate | (E170) |
| Calcium carbonate | — |
| Magnesium carbonate | — |
| Calcium chloride | — |
| Potassium chloride | — |
| Colloidal silicas | — |
| Na silicates | (E551) |
| Ca silicates | (E552) |
| Al silicates | (E553a) |
| Propylene glycol | — |

The preservative is preferably selected from:

| Substance | EEC No. |
|---|---|
| Sorbic acid (and salts) | (E200) |
| Sodium sorbate | (E201) |
| Potassium sorbate | (E202) |
| Calcium sorbate | (E203) |
| Benzoic acid (and salts) | (E210) |
| Citric acid (and salts) | (E330) |
| Sodium benzoate | (E211) |
| Potassium benzoate | (E212) |
| Calcium benzoate | (E213) |

| Substance | EEC No. |
|---|---|
| p-Hydroxybenzoic acid ethyl ester | (E214) |
| p-Hydroxybenzoic acid ethyl ester, Na compound | (E215) |
| p-Hydroxybenzoic acid propyl ester | (E216) |
| p-Hydroxybenzoic acid propyl ester, Na compound | (E217) |
| p-Hydroxybenzoic acid methyl ester | (E218) |
| p-Hydroxybenzoic acid methyl ester, Na compound | (E219) |
| Formic acid (and salts) | (E236) |
| Sodium formate | (E237) |
| Calcium formate | (E238) |

Preferred thickeners are:

| Substance | EEC No. |
|---|---|
| Mono- and diglycerides of edible fatty acids | (E471) |
| Starch (oxidatively degraded) | (E304) |
| Agar agar | (E406) |
| Alginates | |
| Sodium alginate | (E401) |
| Potassium alginate | (E402) |
| Calcium alginate | (E403) |
| Carrageen | (E407) |
| Guar gum | (E412) |
| Locust bean gum | (E410) |
| Tragacanth | (E413) |
| Xanthan | (E415) |
| Cellulose | (E460) |
| Methyl cellulose | (E461) |

| Substance | EEC No. |
|---|---|
| Hydroxypropyl cellulose | (E463) |
| Hydroxypropyl methyl cellulose | (E464) |
| Carboxyethyl cellulose | (E466) |
| Pectin | (E440) |
| Amidated pectin | (E440) |
| Propylene glycol alginate | (E405) |
| Acetylated distarch phosphate | (E1414) |
| Starch acetate (esterified with acetic anhydride) | (E1420) |
| Acetylated distarch adipate | (E1422) |
| Gum arabic | (E414) |
| Gelatine | — |
| Albumins | — |
| Caseinates | — |

For application where the surface treatment composition is intended to form a protective film which can easily be removed after soiling, it is advisable for the composition additionally to contain one or more emulsifiers. The concentration of these emulsifiers is, for example, from about 0.5 to about 2% by weight. The emulsifiers are preferably selected from:

| Substance | EEC No. |
|---|---|
| Mono- and diglycerides of edible fatty acids | |
| esterified with | |
| Acetic acid | (E472a) |
| Lactic acid | (E472b) |
| Citric acid | (E472c) |

| Substance | EEC No. |
|---|---|
| Tartaric acid | (E472d) |
| Monoacetyl and diacetyl tartaric acid | (E472e) |
| Acetic acid and tartaric acid | (E472f) |
| Na, K or Ca compounds of edible fatty acids | (E470) |
| Sugar glycerides | (E474) |
| Polyglycerol esters of edible fatty acids | (E475) |

A second embodiment of the present invention relates to the use of the described surface treatment compositions in food-processing factories. The composition is applied to the surfaces to be treated either in undiluted form or after dilution with at most the same volume of water, i.e. diluted to twice the volume. The surfaces are preferably cleaned beforehand. The composition may be applied by any of the usual methods, for example by immersing the surface in the optionally diluted composition or by wetting the surface with the composition by spread coating, spraying or flooding. The temperature at which the composition is applied is not critical as long as the composition remains flowable. The application temperature may be, for example, between 2 and 80° C. and is preferably of the order of room temperature, i.e. between 15 and 25° C.

In this second embodiment, the invention relates on the one hand to the use of the composition for coating surfaces of containers intended for accommodating foods. The containers can thus be completely and easily emptied with no interference from dried-on foods. On the other hand, the composition may be used to protect other surfaces, such as tables, walls, pipes or ventilation equipment, against adhering soil. The soil, for example dust, settling on the non-drying composition does not come into contact with the actual surface and, accordingly, can easily be removed by wiping with a damp cloth or by spraying with water.

### EXAMPLES

Compositions according to the invention may have the following compositions for example (quantities in % by weight):

| | Example I | Example 2 | Example 3 |
|---|---|---|---|
| Deionized water | 96.8 | 96.8 | 96.8 |
| Glycerol | 2.0 | 2.0 | 2.0 |
| Na benzoate | 0.5 | 0.5 | 0.5 |
| Methyl cellulose | 0.7 | | |
| Xanthan | | 0.7 | |
| Gelatine | | | 0.7 |
| Brookfield viscosity | 4390 mPas | 4930 mPas | 5540 mPas |
| (spindle 3, 22° C., 12 r.p.m.) | | | |
| Drying behavior | Rubber-like, | Rubber-like, | Rubber-like, |
| (1 g on a glass surface, | moist | moist | moist |
| evaluation after 7 days) | | | |

The production of the compositions is illustrated in the following with reference to Example 1:

The water is introduced first, glycerol and sodium benzoate are then added and are completely dissolved. Methyl cellulose is then scattered slowly with stirring onto the surface of the liquid cone formed by stirring. When there is an increase in viscosity, the speed of the stirrer is reduced to prevent any inclusion of air. If a vacuum is applied, the inclusion of air bubbles can be better prevented. At a stirrer speed of about 1,500 r.p.m., the dissolving time is about 30 minutes. At slower stirring speeds, it can be up to about 1 hour. The production process is preferably carried out under the conditions normally used for the production of food additives.

The properties of the compositions according to the invention are illustrated by the following tests:

### Example 4 (Complete Emptying Test)

Pieces of meat (cubes approx. 3×3 cm, 1 kg) are stored for 7 days at 8° C. in a plastic beaker (diameter 15 cm, height 20 cm). Emptying of the meat cubes is then evaluated (emptying rate, residues remaining in the beakers) by turning the beakers upside down.

Beaker 1: untreated

Beaker 2: treated with the composition as described in Example 1

Result: beaker 1 can only be completely emptied by mechanical assistance (tapping). Meat residues remain on the walls of the beaker. Beaker 2 can be quickly and completely emptied.

### Example 5 (Cleaning Test)

The composition of Example 1 was used. A thin film of the composition was applied to various surfaces. After a drying time of 2 h, active carbon powder was scattered onto the surfaces. a) Rinsing behavior and b) removal of the active carbon were evaluated by rinsing with cold water (for about 2 minutes with no mechanical assistance). The results were visually evaluated by comparison with untreated surfaces.

Surface after rinsing with cold water - visual

| Surface | Untreated | Treated |
|---|---|---|
| Glazed ceramic | Distinct grey bloom | Clean |
| Stainless steel (1.4301) | Distinct grey bloom | Clean |
| Plastic (PVC-HD) | Thick grey bloom | Clean (minimal residues) |
| Glass | Distinct grey bloom | Clean |

1. A surface treatment composition containing
90 to 98.5% by weight of water,
1 to 4% by weight of a hygroscopic component,
0.2 to 2% by weight of preservative and
thickener in such a quantity that the viscosity of the mixture (as measured at 22° C. with a Brookfield viscosimeter, spindle 3, 12 r.p.m.) is in the range from 2,000 to 10,000 mpas.

2. A composition as claimed in claim 1, characterized in that it contains 0.3 to 2% by weight of thickener.

3. A composition as claimed in one or both of claims 1 and 2, characterized in that the hygroscopic component is selected from glycerol, aluminium oxides, carbonates (preferably sodium carbonate, potassium carbonate, calcium carbonate, magnesium carbonate), calcium chloride, potassium chloride, colloidal silicas, Na silicates, Ca silicates, Al silicates, propylene glycol.

4. A composition as claimed in one or more of claims 1 to 3, characterized in that the preservative is selected from sorbic acid (and salts), benzoic acid (and salts), citric acid (and salts), formic acid (and salts), p-hydroxybenzoic acid ethyl ester, p-hydroxybenzoic acid ethyl ester, Na compound, p-hydroxybenzoic acid propyl ester, p-hydroxybenzoic acid propyl ester, Na compound, p-hydroxybenzoic acid methyl ester, p-hydroxybenzoic acid methyl ester, Na compound.

5. A composition as claimed in one or more of claims 1 to 4, characterized in that the thickener is selected from mono- and diglycerides of edible fatty acids, starch (oxidatively degraded), agar agar, alginates (preferably sodium alginate, potassium alginate, calcium alginate), carrageen, guar gum, locust bean gum, tragacanth, xanthan, cellulose, methyl cellulose, hydroxypropyl cellulose, hydroxypropyl methyl cellulose, carboxyethyl cellulose, pectin, amidated pectin, propylene glycol alginate, acetylated distarch phosphate, starch acetate (esterified with acetic anhydride), acetylated distarch adipate, gum arabic, gelatine, albumins, caseinates.

6. A composition as claimed in one or more of claims 1 to 5, characterized in that it additionally contains 0.5 to 2% by weight of one or more emulsifiers.

7. A composition as claimed in claim 6, characterized in that the emulsifiers are selected from mono- and diglycerides of edible fatty acids esterified with acetic acid, lactic acid, citric acid, tartaric acid, monoacetyl and diacetyl tartaric acid and/or a combination of acetic acid and tartaric acid; Na, K or Ca compounds of edible fatty acids; sugar glycerides and polyglycerol esters of edible fatty acids.

8. The use of the composition claimed in one or more of claims 1 to 7 for treating surfaces intended to come into contact with foods.

9. The use of the composition claimed in one or more of claims 1 to 7 for treating surfaces in food-processing factories.

10. The use claimed in one or both of claims 8 and 9, characterized in that the composition is applied to the surface in undiluted form or after dilution with no more than the same volume of water by immersing the surface in the composition or by spread coating, spray coating or flood coating.
